(19) United States
(12) Patent Application Publication
(10) Pub. No.: US 2005/0075208 A1
(43) Pub. Date: Apr. 7, 2005

(54) Method and means for variably transferring rotation energy

(76) Inventor: Trygve Holmsen, Slependen (NO)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/450,981

(22) PCT Filed: Dec. 21, 2001
(86) PCT No.: PCT/NO01/00508

(30) Foreign Application Priority Data
Dec. 22, 2000 (NO) 20006654

(51) Int. Cl. F16H 48/06

(52) U.S. Cl. 475/149

(57) ABSTRACT

Method for transferring rotation energy from an input shaft to an output shaft at a continuously variable transmission ratio, whereby direct or indirect energy transfer between the shafts by means of at least one elastic collision involving at least one switch unit capable of controlling energy transfer satisfying the conditions of operating whithout absorbing much energy, operating very fast, operating with minimal internal friction or wear and operating without using friction as a major part in how energy is transferred, combined with the use of at least one elastic unit and optionally the use of energy store units, whereby all three unit categories and units may independently be implemented using mechanical, hydraulic, pneumatic, magnetic or electronic means.

### BACKGROUND OF THE INVENTION

1. Field of the Invention

The present invention is related to a method and a transmission for continuously variable transmission.

2. Description of the Related Art

Known transmission of the above type compromise gearboxes and transmissions which roughly can be grouped into ordinary gearboxes using a combination of cogwheels or toothed wheels, transmissions based on hydraulic torque converters and cogwheels or is toothed wheels, continuously variable transmissions using conic shafts, often in combination with different kind of belts and finally transmissions using energy transfer through variable momentum of inertia.

Known gearboxes and transmissions based on the above mentioned principles have limitations in respect to one ore more of the following. In some cases only a relatively poor efficiency can be achieved. Furthermore are available transmission ratios often limited. In many cases is the response time relatively and unacceptable long. Other known transmission provide restricted operational pattern. Again other transmission has high complexity, high weight, large size and high production cost.

### SUMMARY OF THE INVENTION

The continuously variable transmission according to the present invention avoids the shortages of existing gearboxes and transmission, as defined by the features stated in the claims.

Additionally the transmission according to the present invention provides a high theoretically efficiency, the number of available transmission ratios are ideally unlimited. Due to simplicity of its operational principle it is possible to implement the transmission according to the invention for practical use in applications resulting in higher functionality, radically lower complexity, weight, size and production-cost than comparable existing solutions.

### BRIEF DESCRIPTION OF THE DRAWINGS

The above and other objects, features and advantages of the present invention will become more apparent from the following description taken in connection with the accompanying drawings in which:

FIG. 1 shows the principle solution of the continuously variable transmission.

FIG. 2 shows implementation 1, a typical car transmission, in a longitudal view.

FIG. 3 shows implementation 1 in at cut-trough the middle longitudal view.

FIG. 4 shows implementation 1 in a perspective and partly cut through view.

FIG. 5 shows implementation 1.1, a typical car transmission with reverse/backward capability, in a perspective and partly cut-through view.

FIG. 6 shows implementation 2, a typical bicycle transmission, in a look through along the longitudinal axis.

FIG. 7 shows implementation 2 in a perspective and cut through the middle view.

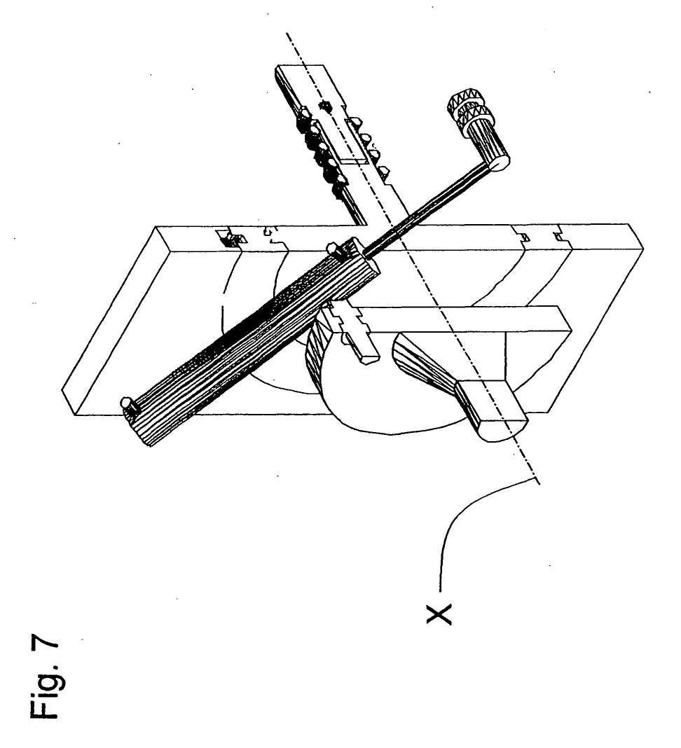

FIG. 8 shows implementation 2 in a view along the longitudal axis in a look through as seen from the left hand side in FIG. 6.

FIG. 9 shows implementation 3, a typical car transmission, in a perspective view.

FIG. 10 shows details of implementation 3 in a longitudal view.

FIG. 11 shows implementation 3 in a view along the longitudal axis.

### DETAILED DESCRIPTION OF THE INVENTION

In general the operational pattern can easily be controlled by low cost computers contributing to highest overall functionality. In other implementations operational pattern can be part of the construction it self.

The operational principle of the transmission is based on the use of elastic collisions, however, in order to implement the principle in a transmission one have to overcome several practical challenges.

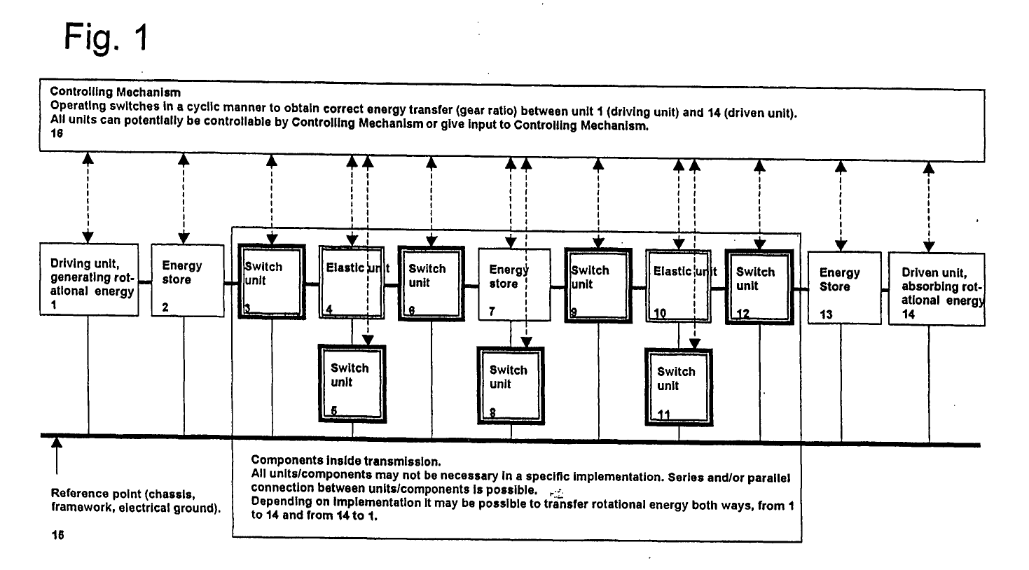

FIG. 1 identifies the three main component categories in the present innovation. Not all units in FIG. 1 may be necessary, neither is the connection to reference point 15 necessary for all units. The categories are as follows:
1. Switch unit. A unit that can control energy transfer, which can be implemented in a number of ways using such as mechanical, hydraulic, pneumatic, magnetic or electric means. In order to be practical useful in the present invention switches 3, 5, 6, 8, 9, 11 and 12 has to satisfy the following four criterias:
   A. Energy associated by the operation of switches themselves is in general not contributing to useful energy transfer between unit 1 and unit 14 in FIG. 1. This calls for switches that operate without absorbing much energy in order to keep the overall efficiency high.
   B. The need for fast response time—quick adoption to ideally energy transfer between unit 1 and unit 14 in FIG. 1—makes it necessary for the switches to be able to operate fast.
   C. In order to obtain a long life cycle it is necessary for switches to operate with minimal internal friction or wear.
   D. To avoid low overall efficiency in energy transfer between unit 1 and unit 14, and to enhance long life cycle, friction is not to play a major part in how the switches transfers energy.
2. Elastic unit. Stores energy due to elastic properties. Can be implemented in a number of ways using such as steel springs, elastic fluid, elastic gas, elastomer, rubber, magnetic field, electric field etc.
3. Energy store unit. Stores energy without having elastic properties. Can be implemented in a number of ways using such as mechanical, hydraulic, pneumatic, magnetic or electronic means.

Units above can be combined into combined-units having characteristic of more than one component category. Not all units in FIG. 1 have to be implemented in order to use the principle of the present innovation. The minimum configuration of the transmission itself consists of at least one elastic unit and at least one switch unit.

Referring to FIG. 1 showing the principle operational process of the present innovation. A driving unit 1 supplies rotational energy through the present innovation to a driven rotational unit 14 that absorbs rotational energy. An energy store 2 may be associated with the momentum of inertia of the driving unit 1 while an energy store 13 may be associated with the momentum of inertia of the driven unit 14. The energy stores 2 and 13 will not be referenced any further in the following principle explanation.

Energy is taken from driving unit 1 in an elastic collision with at least one of the following:
1 Through elastic unit 4 with reference point 15 in FIG. 1.
2 Through elastic unit 4 with energy store 7 in FIG. 1.
3 Not using energy store 7 or elastic unit 10, through elastic unit 4 with driven unit 14 in FIG. 1.
   The energy stored in the elastic unit 4 can be given to at least one of the following:
1 Driving unit 1.
2 Energy store 7.
3 Not using energy store 7 or elastic unit 10, to driven unit 14.
   Energy stored in energy store 7 can be given to at least one of the following:
1 Driving unit 1 through elastic unit 4.
2 Driven unit 14 through elastic unit 10.
3 Through elastic unit 4 with reference point 15.
4 Through elastic unit 10 with reference point 15.
   Energy stored in the elastic unit 10 can be given to at least one of the following:
1 Driven unit 14.
2 Energy store 7.
3 Not using energy store 7 or elastic unit 4, to driving unit 1.

The process described above is possible through the use of switch units. Depending upon practical implementation it may be possible for the present innovation to transfer rotational energy both ways, not only from unit 1 to unit 14 in FIG. 1, but also the opposite way. This as well as implementations of switches will be demonstrated in the later description of practical implementations.

A controlling mechanism is typical operating switch units, it may also operate elastic units—controlling the elasticity, or the energy store units—controlling the energy store capability. Input to the controlling mechanism may be taken from different units. The controlling mechanism may also control elements outside the transmission or receive input from alike in order to achieve the highest degree of functionality.

In order to achieve continuously energy transfer between unit 1 and unit 14 the is controlling mechanism have to initiate elastic collisions at such a frequency, pattern and quantity that a desired energy transfer is achieve between the units.

Additional series and/or parallel connection of the three category units is possible.

The transmission ratio is given by the rotational speed of unit 1 and unit 14, which is ruled by the controlled energy transfer. The major challenge facing a transmission based on the principle of elastic collision is to design practical useful switches.

### Implementation 1

A continuously variable transmission will be described hereinafter as installed in a car in place of an ordinary automatic transmission between engine and a driving shaft, both rotating around the x-axis.

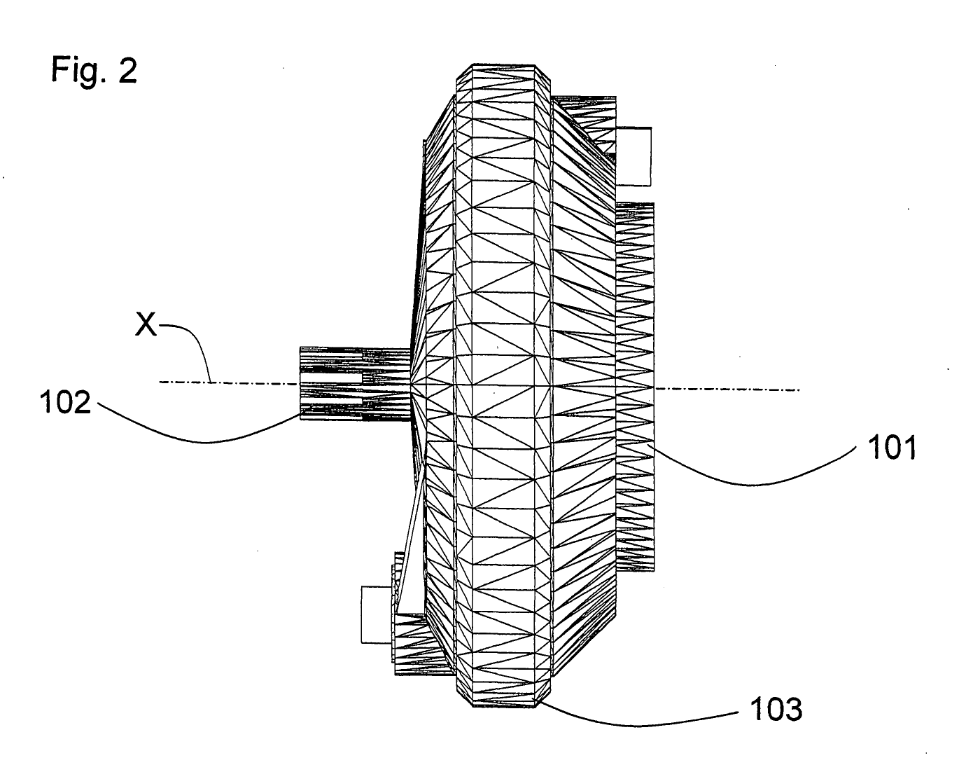

Referring to FIG. 2 showing the transmission in a longitudal view. An engine's rotating shaft is connected to a disc 101 and the driving shaft is connected to a disc 102. A freely rotating ring 103 with a high momentum of inertia obtain rotational energy through an elastic collision with disc 101, storing this energy and then hands rotational energy to disc 102 through an elastic collision with this disc. Discs 101 and 102 and the ring 103 are rotating around the x-axis. In this description of the innovation it is supposed that disc 101 rotates faster than disc 102, if this is not the case, energy can be transferred the opposite way, typical using the car's engine as an engine break.

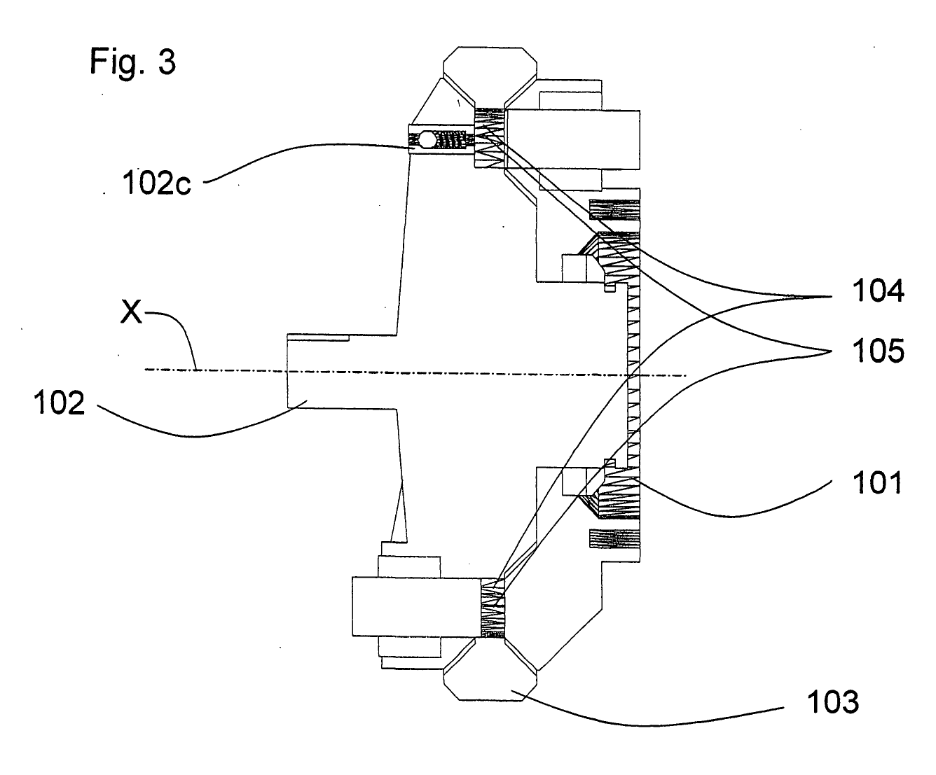

Referring to FIG. 3 showing the transmission in a longitudal view as in FIG. 2, but this time in a cut-trough the middle view. This view discloses a concentric to x-axis circular hollow space 104 filled with elastic fluid 105.

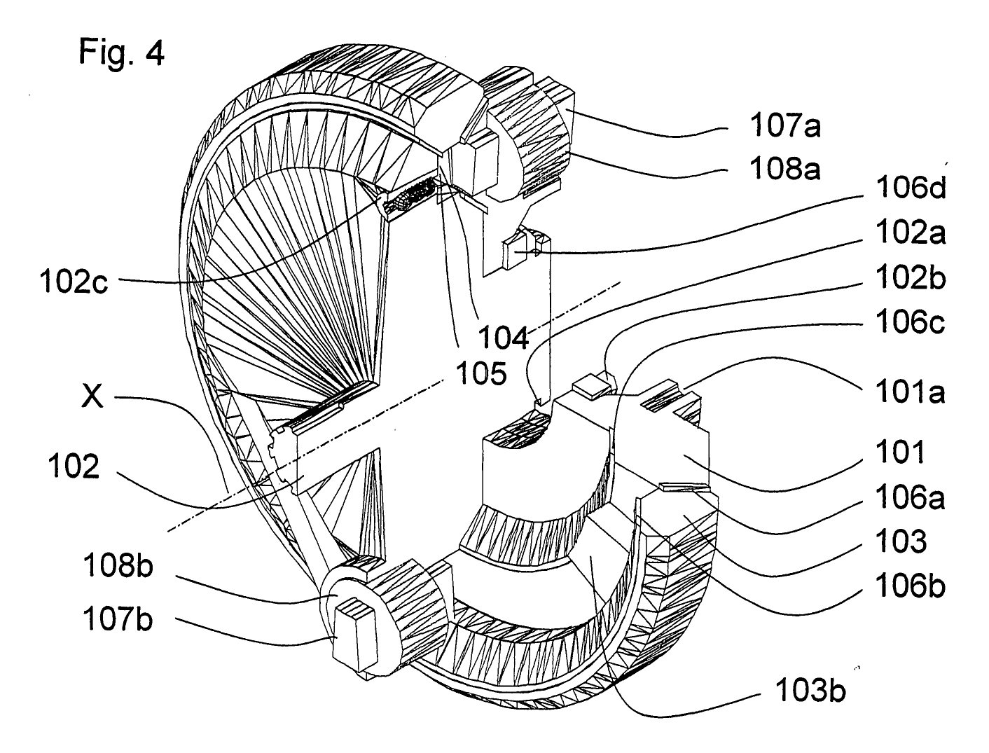

Referring to FIG. 4 showing a low pressure valve 102c that may be useful in order to assure that the fluid pressure in the hollow space 104 does not get to low if the combined bearings and seals 106a, 106b and 106c should show unwanted fluid leakage.

A bearing 106a is provided between the disc 101 and the ring 103, a bearing 106b between the disc 102 and the ring 103, a bearing 106c between the disc 101 and the disc 102, all assuring that disc 101, disc 102 and the ring 103 all can rotate independent of each other. A bearing 106d together with a shim 102b and a snap ring to fit into a groove 102a (snap ring not shown) keeps the disc 101, the disc 102 and the ring 103 tight together and still rotating freely and independently of each other. Screw threads 101a are used for connecting the disc 101 to the engine.

A switch element 107a can be driven by an electromagnet 108a to stabilize in two positions parallel to the x-axis, one position being inside the hollow space 104 effectively closing for any passage of fluid 105, the other position being just outside the hollow space 104 opening for free passage of fluid 105. The switch element 107a can is switch between its two positions very fast assuming low weight of the element itself due to small size and the parallel to x-axis operation leaving operation virtually independent of fluid pressure in hollow space 104.

The combined unit of switch element 107a and the electromagnet 108a is fixed to the disc 101 and thus rotating at the same speed.

The combined unit of switch element 107b and the electromagnet 108b is similarly fixed to the disc 102 and thus rotating at the same speed as disc 102.

The rotating ring 103 has a partition wall 103b connected with the ring 103, which effectively will close for any passage of fluid 105 in the hollow space 104.

Assuming that the disc 101 is rotating, the disc 102 and the ring 103 are at rest. In order to establish an elastic collision between the disc 101 and the ring 103, the switch element 107b has to be out of the hollow space 104, while the switch element 107a has to be out of the hollow space 104 until it is approximately 180° away from the partition wall 103b. The switch element 107a is then driven by an electromagnet 108a into the hollow space 104, effectively establishing a fluid cushion on each side of the switch element 107a and the partition wall 103b. Because of the elasticity of the fluid 105, the ring 103 will experience an elastic collision with the disc 101 and in such a way aquire rotational energy and be accelerated to approximately the same rotational speed as disc 101.

In order to establish an elastic collision between the ring 103 and the disc 102, the switch element 107a has to be out of the hollow space 104, while the switch element 107b has to be out of the hollow space 104 until it is approximately 180° away from the partition wall 103b. The switch element 107b is then driven by an electromagnet 108b into the hollow space 104, effectively establishing a fluid cushion on each side of the switch element 107b and the partition wall 103b. Because of the elasticity of the fluid 105, the disc 102 will experience an elastic collision with the ring 103 and acquire rotational energy. In this process the speed of the ring 103 will be retarded from its current rotational speed to approximately the same rotational speed as the now accelerated disc 102.

The process above passes energy from the engine to the driving shaft via the ring 103. This process is repeated under supervision of the controlling mechanism which operates switch elements 107a and 107b alternately, and so often that wanted energy transfer is achieved between the engine and the driving shaft. The transmission ratio between the discs 101 and 102 is given by the ratio of the rotation speeds of the discs and is controlled by the energy transfer described above.

In a normal operational situation the ring 103 will alternate between approximately the rotational speed of discs 101 and 102. Engine power can only be transferred to the driving shaft if disc 101 rotates faster than the disc 102. High difference in rotational speed between discs 101 and 102 allows higher energy transfer between the engine and the driving shaft, the overall transmission ratio between engine and car wheels must take this fact into account.

The controlling mechanism has sensors connected to discs 101 and 102 and the ring 103 assuring that the switch elements 107a and 107b operate as described, and do not collide with each other or the fixed partition wall 103b. A high momentum of inertia in both engine and driving shaft/wheels assures a steady and smooth rotation of discs 101 and 102.

### Implementation 1.1

Description of implementation 1.1 is basically the same as implementation 1, but with two main differences.

The first difference is that it also offers a reverse capability—switch direction of rotation. The second difference is that it uses an elastic liquid 205b instead of elastic fluid, and because of the relatively higher specific weight of liquid compared to gas, this implementation do not need a freely rotating ring with a high momentum of inertia.

A continuously variable transmission will be described hereinafter as installed in a car in place of an ordinary automatic transmission between the engine and a driving shaft, both rotating around the x-axis.

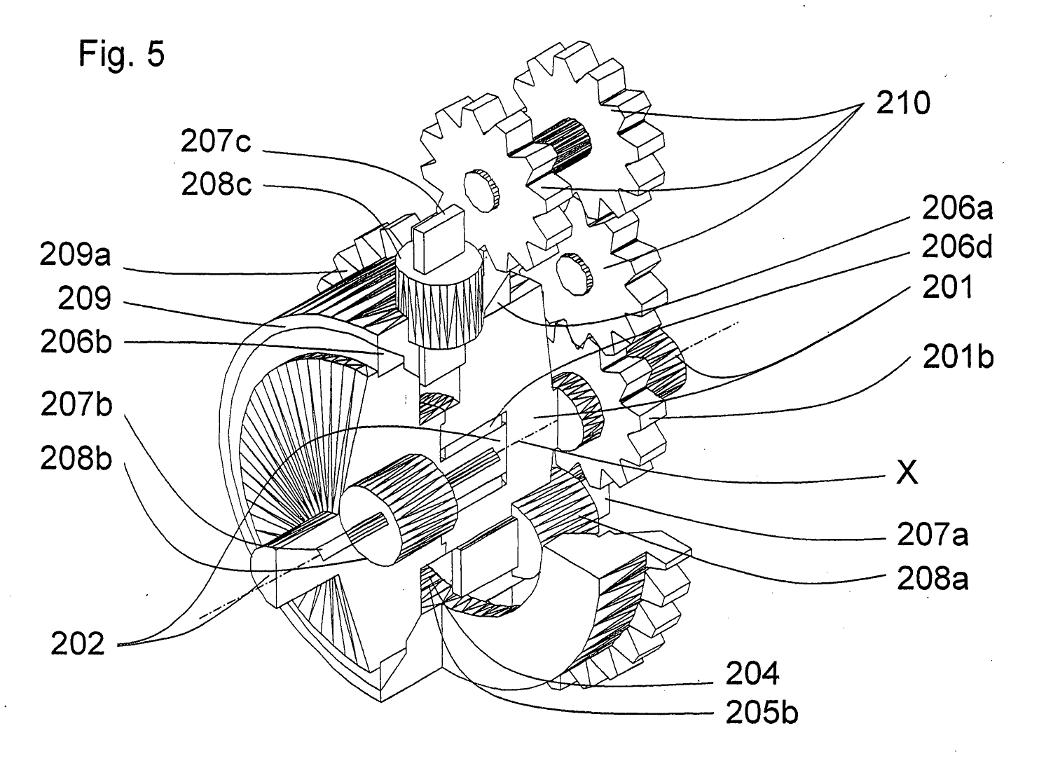

Referring to FIG. 5. The engine's rotating shaft is connected to disc 201 and the driving shaft is connected to a disc 202. A freely rotating ring with the fixed partition wall is not part of this implementation. Instead the concentric to x-axis circular hollow space 204 is filled with the elastic liquid 205b achieving a high momentum of inertia due to high specific weight.

A teethed rotational ring 209 is connected through teethed wheels 210 to a teethed wheel 201b and is thus rotating in the opposite direction of disc 201. For practical reasons it is assumed that the ring 209 is rotating at a lower speed than disc 201 because the car does not need to drive very fast in reverse/backward, but this is not a necessity. Discs 201 and 202 and the ring 209 are rotating around the x-axis.

The combined bearings and seals 206a, 206b and 206d assure that the hollow space 204 is kept free from leakage of the elastic liquid 205b. A bearing 106c is not a part of this implementation. The bearing 206a is between disc 201 and ring 209, bearing 206b between disc 202 and ring 209, bearing 206d between disc 201 and disc 202 all assuring that disc 201, disc 202 and ring 209 all can rotate without friction. Disc 202 rotates freely and independently of the disc 201 and the ring 209.

In this description of the innovation it is supposed that the disc 201 rotates faster than the disc 202 or that the ring 209 rotates faster than disc 202 in case of ‘reverse’ operation. If this is not the case energy can be transferred the opposite way, typical using the car's engine as an engine break.

The switch element 207a can be driven by an electromagnet 208a to stabilize in two positions parallel to the x-axis, one position being inside the hollow space 204 effectively closing for any passage of the liquid 205b, the other position being just outside the hollow space 204, opening for free passage of the liquid 205b. The switch element 207a can switch between its two positions very fast assuming low weight of the element itself due to small size and the parallel to x-axis operation leaving operation virtually independent of the liquid pressure in the hollow space 204. The combined unit of switch element 207a and the electromagnet 208a is fixed to the disc 201 and thus rotating at the same speed.

The combined unit of switch element 207b and electromagnet 208b is similar to the switch element 207a and the electromagnet 208a, but is fixed to the disc 202 and thus rotating at the same speed as disc 202.

The combined unit of switch element 207c and electromagnet 208c is similar to the switch element 207a and the electromagnet 208a, but is fixed to the ring 209 and thus rotating at the same speed as the ring 209.

Assuming that the disc 201 is rotating, the disc 202 and the liquid 205b are at rest. In order to establish an elastic collision between the disc 201 and the liquid 205b, switch elements 207b and 207c have to be out of the hollow space 204. The switch element 207a is then driven by the electromagnet 208a into the hollow space 204, colliding elastically with the liquid 205b that aquires rotational energy. The liquid 205b will be accelerated to approximately the same rotational speed as the disc 201.

In order to establish an elastic collision between the liquid 205b and the disc 202, the switch elements 207a and 207c have to be out of the hollow space 204. The switch element 207b is then driven by the electromagnet 208b into the hollow space 204, colliding elastically with the liquid 205b. The disc 202 will experience an elastic collision with the liquid 205b and acquire rotational energy. In this process the speed of the liquid 205b will be retarded from its current rotational speed to approximately the same rotational speed as the now accelerated disc 202.

To enable reverse operation, assuming that the ring 209 is rotating, the disc 202 and the liquid 205b are at rest. In order to establish an elastic collision between the ring 209 and the liquid 205b, the switch elements 207a and 207b have to be out of the hollow space 204. The switch element 207c is then driven by the electromagnet 208c into the hollow space 204, colliding elastically with the liquid 205b. In this way the liquid 205b will acquire rotational energy with an opposite rotational direction of disc 201.

In order to establish an elastic collision between the now rotating liquid 205b and the disc 202, the switch elements 207a and 207c have to be out of the hollow space 204. The switch element 207b is then driven by the electromagnet 208b into the hollow space 204, colliding elastically with the liquid 205b. The disc 202 will experience an elastic collision with the liquid 205b and acquire rotational energy. In this process the speed of the liquid 205b will be retarded from its current rotational speed to approximately the same rotational speed as the now accelerated disc 202.

The process above passes energy from the engine to the driving shaft via the elastic liquid 205b. This processes is repeated under supervision of the controlling mechanism which operates the switch elements 207a and 207b alternately, and so often that wanted energy transfer is achieved between engine and driving shaft.

For reverse operation the process above passes energy from the engine to the driving shaft via the liquid 205b. This processes is repeated under supervision of the controlling mechanism which operates the switch elements 207c and 207b alternately, and so often that wanted energy transfer is achieved between engine and driving shaft.

The transmission ratio between the disc 201 and the disc 202 is give by the ratio of the rotation speeds of the discs and is controlled by the energy transfer described above.

In a normal operational situation the liquid 205b will alternate between approximately the rotational speed of discs 201 and 202, in reverse operation between approximately the rotational speed of the ring 209 and the disc 202. The engine power can only be transferred to the driving shaft if the disc 201 or the ring 209 rotates faster than the disc 202. High difference in rotational speed between the disc 201 or the ring 209 and the disc 202 allows higher energy transfer between engine and driving shaft, the overall transmission ratio between engine and car wheels must take this fact into account.

A controlling mechanism with sensors connected to the discs 201 and 202 and the ring 209 assures that the switch elements 207a, 207b and 207c operate as described and do not collide with each other.

A high momentum of inertia in both engine and driving shaft/wheels assures a steady and smooth rotation of the discs 201 and 202.

### Implementation 2

A continuously variable transmission will be described hereinafter as installed in a bicycle in place of an ordinary bicycle transmission.

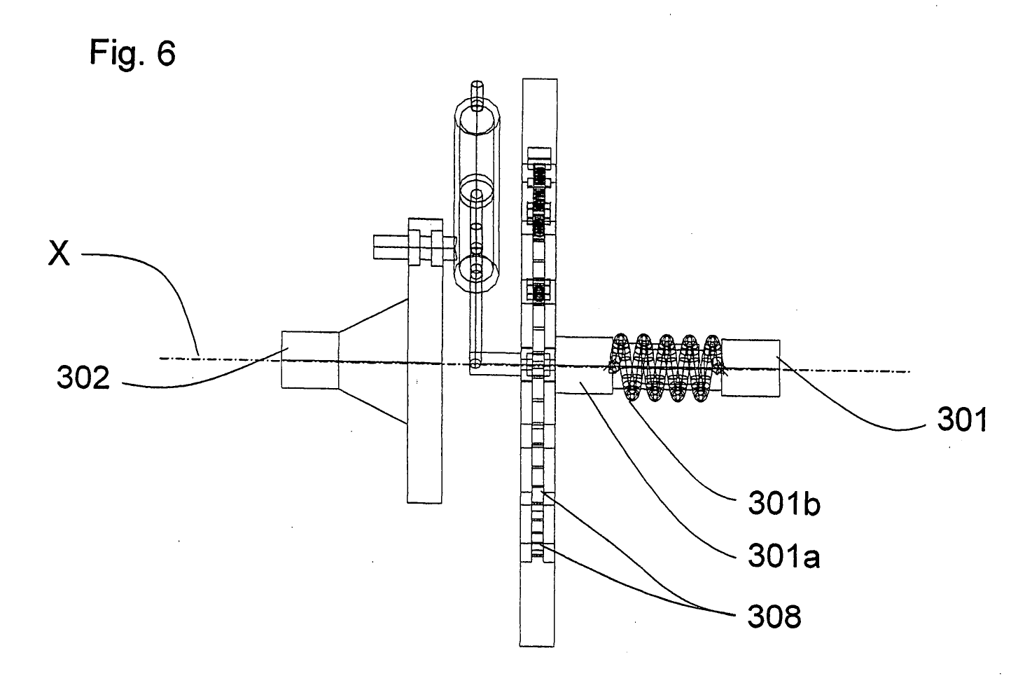

Referring to FIG. 6 showing the transmission in a longitudal view. The pedals are connected to a disc 302 and the driving shaft is connected to a shaft 301. A disc 301a is connected to the shaft 301 through a spring 301b thus allowing temporarily small differences in rotational speed between the shaft 301 and the disc 301a.

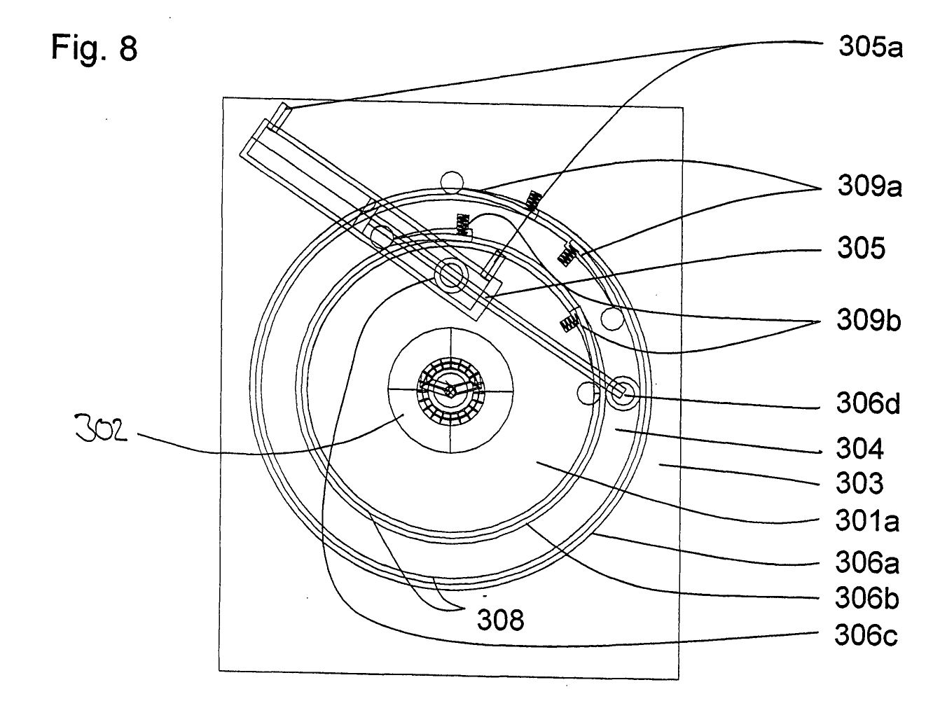

Referring to FIG. 8 showing a frame or a chassis 303 and a rotational ring 304. Hollow spaces 308 are filled with hydraulic oil. Bearing and seal 306a allows rotational ring 304 to rotate independently of frame 303 while keeping hydraulic oil inside a hollow space 308 between the frame 303 and the ring 304. Bearing and seal 306b allows the rotational ring 304 to rotate independently of disc 301a while keeping hydraulic oil inside the hollow space 308 between the disc 301a and the ring 304. A piston pump 305 is filled with elastic fluid and is connected with the disc 302 through a bearing 306c, and connected with the ring 304 through a bearing 306d. When disc 302 is rotating clockwise, the pump 305 will act as an elastic spring between the disc 302 and the ring 304. The ring 304 will begin rotating clockwise, and assuming that the disc 301a is opposing to rotational movement, so will the ring 304 due to operation of one way valves 309b operating hydraulic liquid in hollow space 308. As the disc 302 rotates even more, the pump 305 compresses elastic fluid inside the piston pump more, making the force on the ring 304 rise. Assuming the force exercised by the pump 305 is making the disc 301a starting to rotate, rotational energy may be given to the driving shaft 301 through the spring 301b in FIG. 6 in an elastic push. Assuming disc 302 rotates faster than ring 304, the bearing 306c will pass the bearing 306d and thereby activate one way valves 309a operating hydraulic liquid in hollow space 308 as pump 305 decompresses between frame 303 and disc 302, giving rotational energy back to the disc 302 through an elastic push.

Energy given back to the disc 302 in this way is dependent upon the rotational speed of the disc 301a and the shaft 301.

A controlling mechanism may adjust the spring constant of the piston pump 305 through valves 305a and thereby energy transfer between the disc 302 and the shaft 301. A controlling mechanism may be omitted choosing the right spring constant of the piston pump 305 for a given situation. The transmission ratio between the disc 302 and the shaft 301 is given by the ratio of the rotation speeds and is controlled by the energy transfer described above.

### Implementation 3

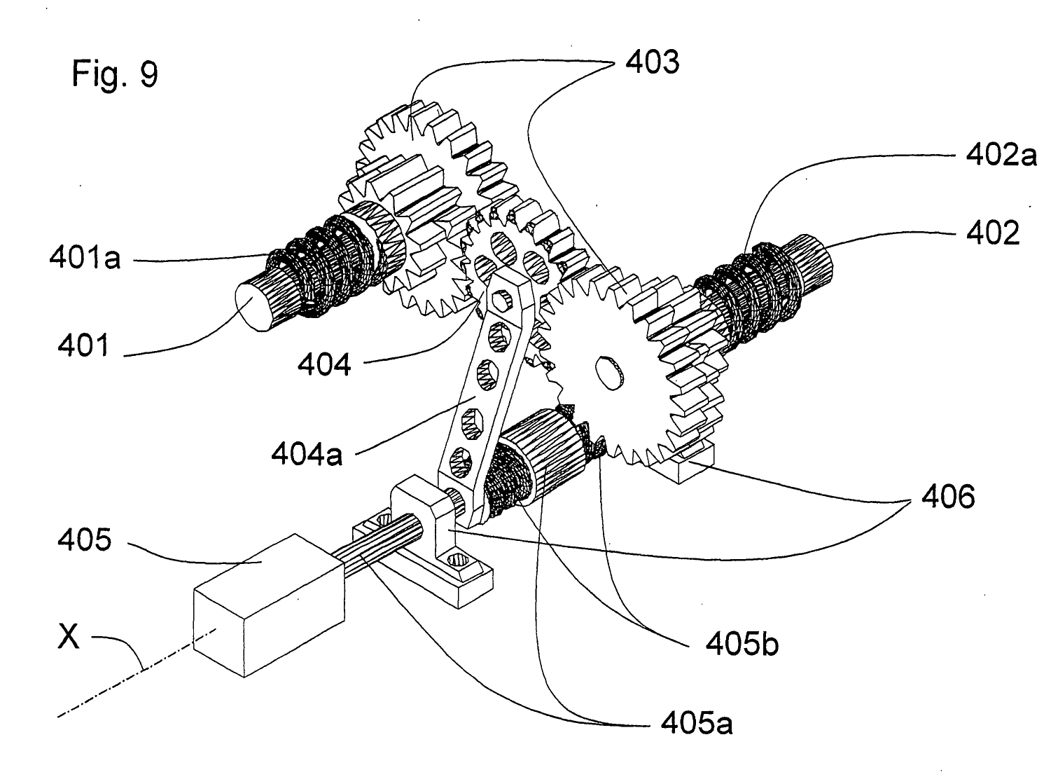

A continuously variable transmission will be described hereinafter as installed in a car in place of an ordinary manual gearbox using a combination of cogwheels or toothed wheels. Referring to FIG. 9, the engine's rotating shaft is connected to a shaft 401 and the driving shaft is connected to a shaft 402.

A teethed wheel 404 can connect teethed wheels 403 with ratio 2:1 and ratio 1:2 by choosing either of the outmost circumferences on the wheels 403. The middle circumference on the wheels 403 is so shaped that it is possible for the wheel 404 to move in a longitudal way along the x-axis from one outmost position on the wheels 403 to the other. This is achieved when the wheels 403 are rotating and an pneumatic servo 405 through a rod 405a with guides 406 and a spring 405b exercises longitudal force on a symmetrical leg 404a and thereby the wheel 404. Springs 405b and the soft cut edges of the wheel 404 assure that this process is achieved without excess force or friction between the wheel 404 and the wheels 403, but still sufficient fast.

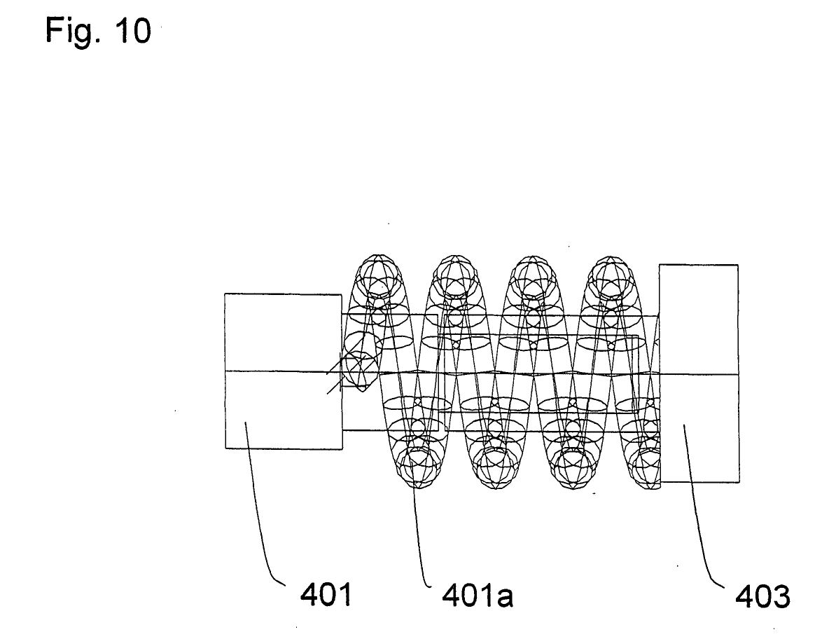

If the wheel 404 is all the time at one outmost circumference the ratio is say 2:1. If the wheel 404 is spending 50% of the time at each outmost circumference the ratio between the shaft 401 and the shaft 402 is in time average 1:1. If the wheel 404 is all the time at the other outmost circumference the ratio between the shaft 401 and the shaft 402 is 1:2. By devoting major time spent by the wheel 404 to one or the other outmost circumference it is possible to achieve different transmission ratios in the interval between 2:1 and 1:2 on a time average. This is controlled by a controlling mechanism. The shaft 401 is connected to the associated wheel 403 through a spring 401a, the shaft 402 is connected to the associated wheel 403 through a spring 402a. This principle is shown in FIG. 10. In this way the variable transmission ratios will express elastic collision between the shafts 401 and 402, allowing the transmission ratio to be given by its average over time.

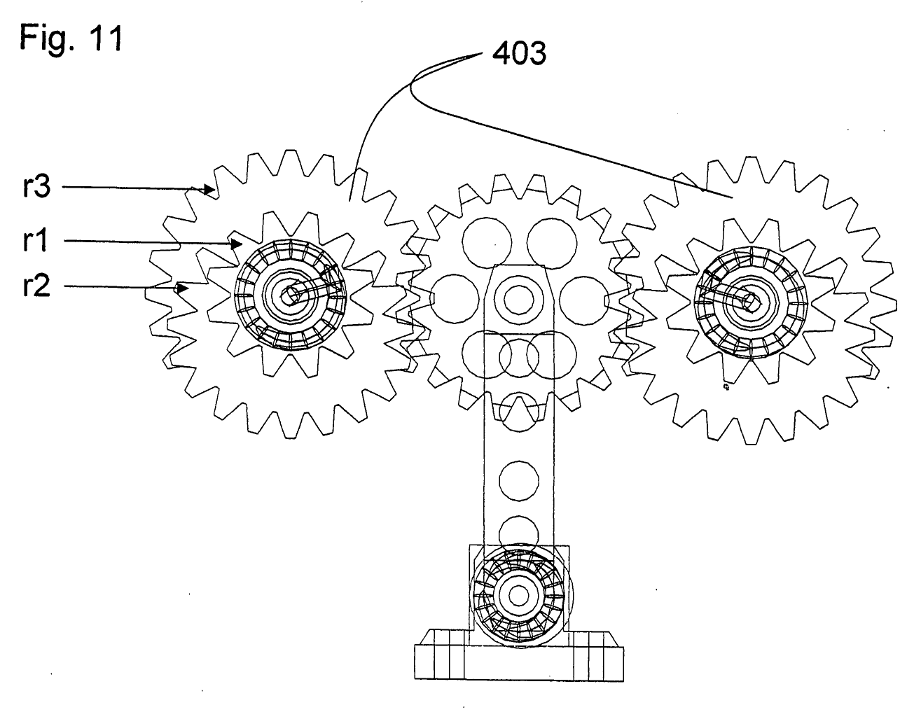

FIG. 11 shows the teethed wheels used in this implementation. Each wheel 403 consist of three teethed wheels, the outmost having the radius r1 respectively r3=2·r1. The teethed unsymmetrical wheel in the middle has a radius r2 given by approximately:
0<=v<90°: r2=r1
90<=v<180°: r2=r1(1+(v−90)/90)
180<=v<270°: r2=2·r1=r3
270<=v<360°: r2=r1(2−(v−270)/90)

In FIGS. 9 and 11 the radius r1 is associated with 12 teeth, the radius r3 with 24 teeth, but other combinations may be found. Different tooth shapes may be found useful.

The wheels 403 and 404, the symmetrical leg 404a, the pneumatic servo 405, the rod 405a wirh guides 406 and the spring 405b may be looked upon as one switch unit.

A controlling mechanism may adjust the time constants wheel 404 spend at the two outmost circumferences on wheels 403 and thereby the average transmission ratio.

Practical Applications

The transmission according to the present invention is in general a substitute for existing gears and transmissions and may find practical applications for example in cars, motor cycles, commercial vehicles or locomotives, for instance between the engine and the drive shaft. Furthermore in bicycles for instance between pedal and drive shaft, in boats for instance between engine and propeller, in power plants for instance between turbines and generator, in power tools for instance between engine and driving shaft and in toys for instance between engine and driving shaft.

1. Method for transferring rotation energy from a rotating input shaft to a rotating output shaft at a continuously variable transmission ratio, characterized in using at least one switch unit that establishes at least one elastic collision between the input shaft and at least one reference point or at least one energy store unit through at least one elastic unit whereby possible energy stored in elastic unit and optionally energy store unit may be given to the output shaft by using at least one switch unit that establishes at least one elastic collision between the reference point or energy store unit and the output shaft through at least one elastic unit whereby the transmission ratio between input shaft and output shaft is controlled by the energy transfer established by the at least one elastic collision, whereby the at least one switch unit operates very fast and not using friction as a major part in how energy is transferred through the at least one elastic unit and whereby all three unit categories and units may independently be implemented using mechanical, hydraulic, pneumatic, magnetic or electronic means.

2. Method according to claim 1, characterized in that the current invention in one of its simplest implementations in one phase of operation uses a switch unit (3) to establish an elastic collision between a rotating input shaft (1) through an elastic unit (4) with a reference point (15) whereby the elastic unit (4) accumulates energy that in an another phase of operation is released between a reference point (15) through a switch unit (12) to establish an elastic collision with a rotating output shaft (14).

3. Method according to claims 1-2, characterized in that the current invention in one of its simplest implementations in one phase of operation uses a switch unit (3) to establish an elastic collision between a rotating input shaft (1) through an elastic unit (4) with an energy store (7) whereby the energy store (7) accumulates energy that in an another phase of operation is released between energy store (7) through an elastic unit (10) and a switch unit (12) to establish an elastic collision with a rotating output shaft (14).

4. Method according to claims 1-3, characterized in that the current invention may be implemented using compound units having properties of more than one category of units.

5. Method according to claims 1-4, characterized in that the current invention may be implemented as a combination of simpler implementations operating in both parallel and serial connections.

6. Means for transferring rotation energy from an input shaft to an output shaft at a continuously variable transmission ratio, characterized in using at least one switch unit that in a first phase of operation transfers energy between the rotating input shaft through at least one elastic unit connected to a reference point such as the chassis or at least one energy store unit whereby in the next phase of operation at least one switch unit transfers possible energy from elastic unit and optionally energy store unit through at least one elastic unit connected to the rotating output shaft whereby all three unit categories and units may independently be implemented using mechanical, hydraulic, pneumatic, magnetic or electronic means and may independently be implemented in parallel operation or connection and may independently be implemented in serial operation or connection.

7. Means according to claim 6 being characterized in using a hydraulic pump to convert mechanical energy into a hydraulic energy or vice versa.

8. Means according to claims 6-7 being characterized in using a pneumatic pump to convert mechanical energy into a pneumatic energy or vice versa.

9. Means according to claims 6-8 being characterized in using a generator to convert mechanical energy into electrical or magnetically energy or vice versa.

10. Means according to claims 6-9 using a simple mechanical switch being characterized in that it transfers energy using a controllable direct mechanical interaction such as movable mechanical links or a mechanical particle flow controlled by valves or direction of particle flow.

11. Means according to claims 6-10 using a simple hydraulic switch being characterized in that it uses a hydraulic fluid flow where energy flow in the fluid is being controlled by valves or direction of fluid flow.

12. Means according to claims 6-11 using a simple pneumatic switch being characterized in that it uses a pneumatic fluid or gas flow where energy flow in the fluid or gas is being controlled by valves or direction of fluid or gas flow.

13. Means according to claims 6-12 using a simple magnetic switch being characterized in that it uses a magnetic field flow where energy flow in the field is being controlled by electrical switches or direction of magnetic field flow.

14. Means according to claims 6-13 using a simple electrical switch being characterized in that it uses electrical current where energy flow in the current is being controlled by electrical current switches or direction of electric particle flow.

15. Means according to claims 6-14 using a mechanical elastic unit being characterized in that it mechanically elastically can absorb, store and release energy such as a mechanical spring.

16. Means according to claims 6-15 using a hydraulically elastic unit being characterized in that it hydraulically elastically can absorb, store and release energy such as an elastically compressible hydraulic fluid.

17. Means according to claims 6-16 using a pneumatic elastic unit being characterized in that it pneumatic elastically can absorb, store and release energy such as an elastically compressible pneumatic fluid or gas.

18. Means according to claims 6-17 using a magnetic elastic unit being characterized in that it magnetic elastically can absorb, store and release energy such as elastically forces between opposing or attracting magnetic fields.

19. Means according to claims 6-18 using a electronic elastic unit being characterized in that it elastically can absorb, store and release electrical energy such as a electronic coil or forces between opposing or attracting electrical fields.

20. Means according to claims 6-19 using a mechanical energy store unit being characterized in that it mechanically stores energy such as a rotating mass or a moving mechanical particle flow.

21. Means according to claims 6-20 using a hydraulic energy store unit being characterized in that it hydraulic stores energy such as a moving hydraulic fluid flow.

22. Means according to claims 6-21 using a pneumatic energy store unit being characterized in that it pneumatic stores energy such as moving pneumatic fluid or gas flow.

23. Means according to claims 6-22 using a magnetic energy store unit being characterized in that it magnetically stores energy such as in a magnetic field flow.

24. Means according to claims 6-23 using a electrical energy store unit being characterized in that it electrically stores energy such as in an electrical condenser.

25. A continuously variable transmission, characterized in a first disc (101) being independently rotatably connected to a second disc (102) and to an outer ring (103) defining a circumferential hollow space (104), a partition wall (103b) within the space (104) being connected to the ring (103) and at least one first switch unit compromising switch element (107a) and a electromagnet (108a) being secured to first disc (101), the space (104) comprising elastic medium such as fluid (105), the at least one second switch unit compromising(107b) and (108b) reciprocing the switch unit (107a) and (108a) but being secured to second disc (102), both switch units being able to switch their switch elements (107a) and (107b) between an outer and inner position inside space (104).

26. A continuously variable transmission, characterized in a first disc (201) being independently rotatably connected to a second disc (202) and dependent reverse rotatably using teethed wheels (201b, 210) and a teeth (209a) to an outer ring (209) defining a circumferential hollow space (204), and at least one first switch unit compromising switch element (207a) and a electromagnet (208a) being secured to first disc (201), the space (204) compromising elastic medium such as a fluid (205b), the at least one second switch unit compromising(207b) and (208b) reciprocing the switch unit (207a) and (208a) but being secured to second disc (202) and the at least one third switch unit compromising (207c) and (208c) reciproing the switch unit (207a) and (208a) but being secured to second ring (209), all three switch units being able to switch their switch elements (207a, 207b, 207c) between an outer and an inner position inside the space (204).
